(19) United States
(12) Patent Application Publication
(10) Pub. No.: US 2024/0028363 A1
(43) Pub. Date: Jan. 25, 2024

(54) PROVIDING AVAILABILITY OF PASSTHROUGH DEVICES CONFIGURED ON VIRTUAL COMPUTING INSTANCES

(71) Applicant: VMware, Inc., Palo Alto, CA (US)

(72) Inventors: Sowgandh Sunil Gadi, San Jose, CA (US); Venkata Subhash Reddy Peddamallu, Sugar Hill, GA (US)

(73) Assignee: VMware, Inc., Palo Alto, CA (US)

(21) Appl. No.: 17/871,500

(22) Filed: Jul. 22, 2022

(51) Int. Cl. G06F 9/455

(52) U.S. Cl. CPC G06F 9/45558; G06F 2009/4557; G06F 2009/45562

(57) ABSTRACT

The present disclosure relates to providing availability of passthrough devices configured on VCIs according to one or more embodiments of the present disclosure. One method includes receiving a notification of a failure associated with a passthrough device configured on a VCI, communicating, to the VCI, a simulation of a surprise hot removal of the device from the VCI, resetting the device, communicating, to the VCI, a simulation of a surprise hot add of the device to the VCI, and hot adding the device to the VCI.

### BACKGROUND

A data center is a facility that houses servers, data storage devices, and/or other associated components such as backup power supplies, redundant data communications connections, environmental controls such as air conditioning and/or fire suppression, and/or various security systems. A data center may be maintained by an information technology (IT) service provider. An enterprise may utilize data storage and/or data processing services from the provider in order to run applications that handle the enterprises' core business and operational data. The applications may be proprietary and used exclusively by the enterprise or made available through a network for anyone to access and use.

Virtual computing instances (VCIs), such as virtual machines and containers, have been introduced to lower data center capital investment in facilities and operational expenses and reduce energy consumption. A VCI is a software implementation of a computer that executes application software analogously to a physical computer. VCIs have the advantage of not being bound to physical resources, which allows VCIs to be moved around and scaled to meet changing demands of an enterprise without affecting the use of the enterprise's applications. In a software-defined data center, storage resources may be allocated to VCIs in various ways, such as through network attached storage (NAS), a storage area network (SAN) such as fiber channel and/or Internet small computer system interface (iSCSI), a virtual SAN, and/or raw device mappings, among others.

### BRIEF DESCRIPTION OF THE DRAWINGS

FIG. 1 is a diagram of a host and a system for providing availability of passthrough devices configured on VCIs according to one or more embodiments of the present disclosure.

FIG. 2 illustrates a plurality of layers associated with providing availability of passthrough devices configured on VCIs according to one or more embodiments of the present disclosure.

FIG. 3 illustrates a method of providing availability of passthrough devices configured on VCIs according to one or more embodiments of the present disclosure.

FIG. 4 is a diagram of a system for providing availability of passthrough devices configured on VCIs according to one or more embodiments of the present disclosure.

FIG. 5 is a diagram of a machine for providing availability of passthrough devices configured on VCIs according to one or more embodiments of the present disclosure.

### DETAILED DESCRIPTION

The term “virtual computing instance” (VCI) refers generally to an isolated user space instance, which can be executed within a virtualized environment. Other technologies aside from hardware virtualization can provide isolated user space instances, also referred to as data compute nodes. Data compute nodes may include non-virtualized physical hosts, VCIs, containers that run on top of a host operating system without a hypervisor or separate operating system, and/or hypervisor kernel network interface modules, among others. Hypervisor kernel network interface modules are non-VCI data compute nodes that include a network stack with a hypervisor kernel network interface and receive/transmit threads.

VCIs, in some embodiments, operate with their own guest operating systems on a host using resources of the host virtualized by virtualization software (e.g., a hypervisor, virtual machine monitor, etc.). The tenant (i.e., the owner of the VCI) can choose which applications to operate on top of the guest operating system. Some containers, on the other hand, are constructs that run on top of a host operating system without the need for a hypervisor or separate guest operating system. The host operating system can use name spaces to isolate the containers from each other and therefore can provide operating-system level segregation of the different groups of applications that operate within different containers. This segregation is akin to the VCI segregation that may be offered in hypervisor-virtualized environments that virtualize system hardware, and thus can be viewed as a form of virtualization that isolates different groups of applications that operate in different containers. Such containers may be more lightweight than VCIs.

While the specification refers generally to VCIs, the examples given could be any type of data compute node, including physical hosts, VCIs, non-VCI containers, and hypervisor kernel network interface modules. Embodiments of the present disclosure can include combinations of different types of data compute nodes.

VCIs can be granted access to hardware devices. More specifically, a guest operating system (OS) running on a VCI can be granted direct access to physical Peripheral Component Interconnect (PCI) functions on platforms with an I/O Memory Management Unit. PCI passthrough, as it is commonly referred to, allows guests to have exclusive access to PCI devices for a range of tasks. PCI passthrough allows PCI devices to appear and behave as if they were physically attached to the guest OS. PCI devices are known to those of skill in the art and include, for example, storage devices, networking devices, graphics devices (e.g., graphics cards, graphics processing units (GPUs), etc.), and others.

In previous approaches, the availability of a VCI may be jeopardized by some failure associated with a configured passthrough device. A “failure” associated with a passthrough device, as referred to herein, is an error or a fault originating at, or caused by, that passthrough device. For example, if a PCI Express (PCIe) uncorrectable error occurs because of a passthrough device, the hypervisor is at risk of crashing. Additionally, if a passthrough device causes an input-output memory management unit (IOMMU) fault, the VCI may be terminated as a matter of course. Such failures cause undesirable downtime in previous approaches.

Embodiments of the present disclosure can handle such failures without the undesirable outcomes of hypervisor crash and/or VCI termination. In some embodiments, a PCIe uncorrectable error or an IOMMU fault can be addressed in less than one second and availability of the VCI can be provided. As discussed further below, some embodiments include detecting a failure associated with a passthrough device and simulating a “surprise hot removal” of the device from the VCI. When the device has been successfully reset and is back to an accessible state it can be “hot added” back to the VCI and resume its function as a passthrough device.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

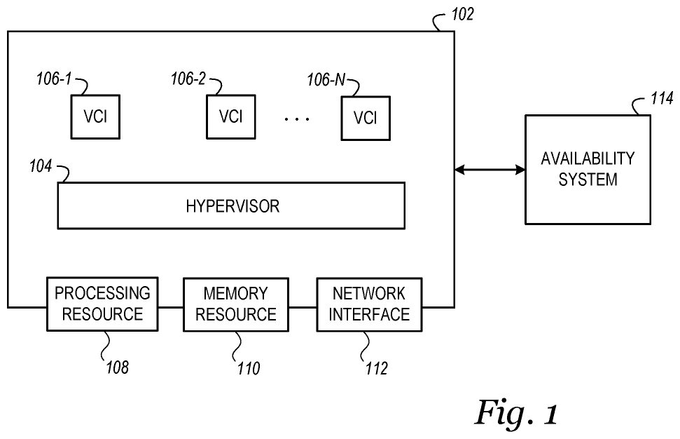

The figures herein follow a numbering convention in which the first digit or digits correspond to the drawing figure number and the remaining digits identify an element or component in the drawing. Analogous elements within a Figure may be referenced with a hyphen and extra numeral or letter. Such analogous elements may be generally referenced without the hyphen and extra numeral or letter. For example, elements 108-1, 108-2, and 108-N in FIG. 1 may be collectively referenced as 108. As used herein, the designator “N”, particularly with respect to reference numerals in the drawings, indicates that a number of the particular feature so designated can be included. As will be appreciated, elements shown in the various embodiments herein can be added, exchanged, and/or eliminated so as to provide a number of additional embodiments of the present disclosure. In addition, as will be appreciated, the proportion and the relative scale of the elements provided in the figures are intended to illustrate certain embodiments of the present invention and should not be taken in a limiting sense.

FIG. 1 is a diagram of a host and a system for providing availability of passthrough devices configured on VCIs according to one or more embodiments of the present disclosure. The system can include a host 102 with processing resources 108 (e.g., a number of processors), memory resources 110, and/or a network interface 112. The host 102 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The host 102 can incorporate a hypervisor 104 that can execute a number of virtual computing instances 106-1, 106-2, . . . , 106-N (referred to generally herein as “VCIs 106”). The VCIs can be provisioned with processing resources 108 and/or memory resources 110 and can communicate via the network interface 112. The processing resources 108 and the memory resources 110 provisioned to the VCIs can be local and/or remote to the host 102. For example, in a software defined data center, the VCIs 106 can be provisioned with resources that are generally available to the software defined data center and not tied to any particular hardware device. By way of example, the memory resources 110 can include volatile and/or non-volatile memory available to the VCIs 106. The VCIs 106 can be moved to different hosts (not specifically illustrated), such that a different hypervisor manages the VCIs 106. The host 102 can be in communication with the availability system 114. In some embodiments, the availability system 114 can be deployed on a server, such as a web server. The availability system 114 can include computing resources (e.g., processing resources and/or memory resources in the form of hardware, circuitry, and/or logic, etc.) to perform various operations to provide availability of passthrough devices configured on VCIs, as described in more detail herein.

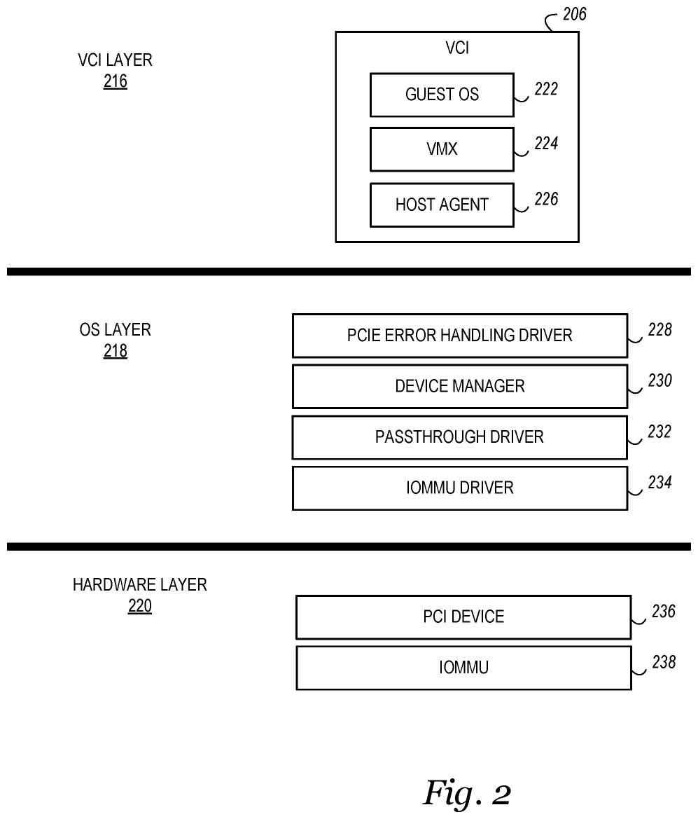

FIG. 2 illustrates a plurality of layers associated with providing availability of passthrough devices configured on VCIs according to one or more embodiments of the present disclosure. As shown in FIG. 2, the plurality of layers includes a VCI layer 216, an operating system (OS) layer 218, and a hardware layer 220.

As shown in FIG. 2, the VCI layer 216 includes a VCI 208. While one VCI 208 is shown in the example illustrated in FIG. 2, it is noted that embodiments herein are not so limited. The VCI 208 can include a guest OS 222, a configuration file (sometimes referred to herein as “VMX”) 224, and a host agent 226. The guest OS 222 is an operating system that runs inside the VCI 208. The VMX 224 is a configuration file which may be used by virtualization software. The VMX 224 stores settings for the VCI 208. The VMX 224 can include a VCI's memory, hard disk, and processor limit settings. The host agent 226 can extend the functions of a host to provide additional services. For example, a solution might require a particular network filter or firewall configuration to function. A solution can use the host agent 226 to connect to the Hypervisor and extend the host with functions specific to that solution. For example, the host agent 226 can filter network traffic, act as a firewall, or gather other information about the VCIs on the host.

The OS layer 218 can a Portable Operating System Interface (POSIX)-like OS. It acts as a liaison between the VCI 208 and the physical hardware that supports it, such as hosts and/or the device(s) of the hardware layer 220. A VCI may utilize the OS layer 218 to communicate with the host server, for instance. As shown in FIG. 2, the OS layer can include a PCIe error handling driver 228, a device manager 230, a passthrough driver 232, and an IOMMU driver 234. The functionalities of the drivers of the OS layer 218 are discussed in more detail below.

The hardware layer can include one or more passthrough devices. As shown in FIG. 2, the hardware layer 220 can include a PCI device 236 and an IOMMU 238. While one PCI device 236 and one IOMMU 238 are illustrated in FIG. 2, it is noted that embodiments herein are not so limited. The PCI device 236 can be any suitable PCI device known to those of skill in the art. Example PCI devices 236 include storage devices, networking devices, graphics devices, etc. As previously discussed, the VCI 208 can be granted direct access to physical PCI functions (e.g., the PCI device 236) on platforms via the IOMMU 238.

A PCIe error from the PCI device 236 can be isolated from the guest OS 222 by the OS layer 218. In some embodiments, when a PCIe error is detected (e.g., by the PCI device 236) platform firmware (e.g., the availability system 114, previously described in connection with FIG. 1), sends a notification to the OS layer 218. The notification can be sent via Advanced Configuration and Power Interface (ACPI) Error Disconnect Recover (EDR). The PCIe error handling driver 228 can read and log details associated with the error. In some embodiments, the OS layer 218 can “simulate” a hot removal of the PCI device 236 from the VCI 208. Stated differently, the OS layer 218 can make it appear like the PCI device 236 was surprise hot removed. For instance, the PCIe error handling driver 228 can send a hot remove event to the device manager 230. In some embodiments, the device manager 230, upon receiving the hot remove event, calls the passthrough driver 232 to detach from the PCI device 236. The passthrough driver 232 can send the hot remove event to the VMX 224 and the host agent 226. Responsive to receiving the hot remove event, the VMX 224 can send a PCIe hot remove interrupt to the guest OS 222. In some embodiments, the guest OS 222 handles the hot remove interrupt, unloads drivers associated with the PCI device 236, and removes the device 236. The PCIe error handling driver 228 can reset the PCI device 236 and wait for the device 236 to return to an “accessible” state. The PCIe error handling driver 228 can post a hot add event to the device manager 230. The device manager 230, upon receiving the hot add event, can scan the bus and rediscover the device 236. Upon rediscovery, the device manager 230 can bind the passthrough driver 232 to the device 236. The passthrough driver 232 can post the hot add event to the VMX 224 and the host agent 226. The VMX can send a PCIe hot add interrupt to the guest OS 222. In some embodiments, the guest OS 222 handles the hot add interrupt, rediscovers the device 236, and loads drivers associated with the device 236, rendering the device 236 again a passthrough device. In some embodiments, the entire process can take less than one second versus previous approaches that may have caused the hypervisor (now shown in FIG. 2) to crash.

When an IOMMU fault is caused by a passthrough device, the fault may be isolated from the guest OS 222 by the OS layer 218. An IOMMU fault may be caused by some failure in the IOMMU 238, for instance. When such a fault is caused, platform firmware can send an IOMMU fault interrupt to the OS layer 218. The IOMMU driver 234 can read and log details associated with the fault. The IOMMU driver 234 can send a hot remove event to the device manager 230. In some embodiments, the device manager 230, upon receiving the hot remove event, calls the passthrough driver 232 to detach from the PCI device 236. The passthrough driver 232 can send the hot remove event to the VMX 224 and the host agent 226. Responsive to receiving the hot remove event, the VMX 224 can send a PCIe hot remove interrupt to the guest OS 222. In some embodiments, the guest OS 222 handles the hot remove interrupt, unloads drivers associated with the PCI device 236, and removes the device 236. The IOMMU driver 234 can reset the PCI device 236 and wait for the device 236 to return to an accessible state. The IOMMU driver 234 can post a hot add event to the device manager 230. The device manager 230, upon receiving the hot add event, can scan the bus and rediscover the device 236. The IOMMU driver 234 can post the hot add event to the VMX 224 and the host agent 226. The VMX can send a PCIe hot add interrupt to the guest OS 222. In some embodiments, the guest OS 222 handles the hot add interrupt, rediscovers the device 236, and loads drivers associated with the device 236, rendering the device 236 again a passthrough device.

In some embodiments, the passthrough driver 232, rather than the PCIe error handling driver 228 or the IOMMU driver 234, can perform the reset of the device 236. In such embodiments, the device manager 230 may not be involved in the process.

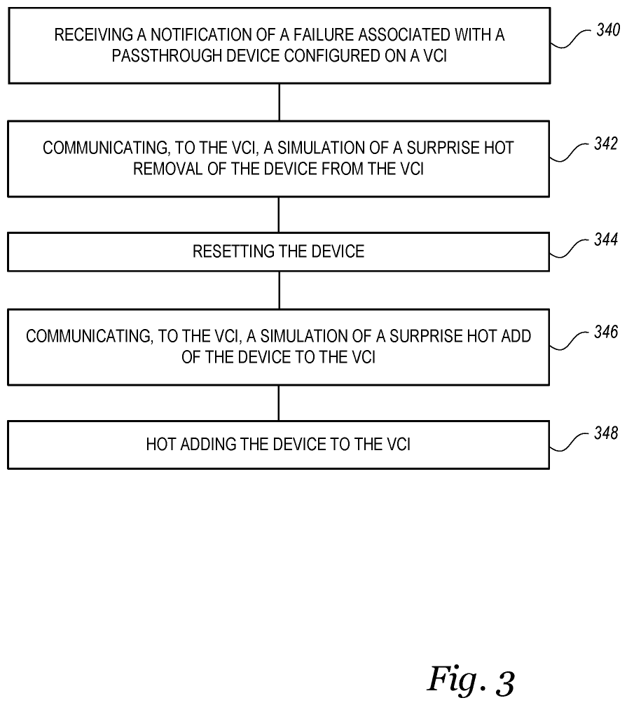

FIG. 3 illustrates a method of providing availability of passthrough devices configured on VCIs according to one or more embodiments of the present disclosure. The method includes, at 340, receiving a notification of a failure associated with a passthrough device configured on a virtual computing instance (VCI). The method includes, at 342, communicating, to the VCI, a simulation of a surprise hot removal of the device from the VCI. The simulation of the surprise hot removal can include a plurality of steps carried out by the OS layer, for instance, in order to make it appear as though the device was hot removed. The method includes, at 344, resetting the device. The method includes, at 346, communicating, to the VCI, a simulation of a surprise hot add of the device to the VCI. The method includes, at 348, hot adding the device to the VCI. As discussed herein, once added, the device again can become a passthrough device.

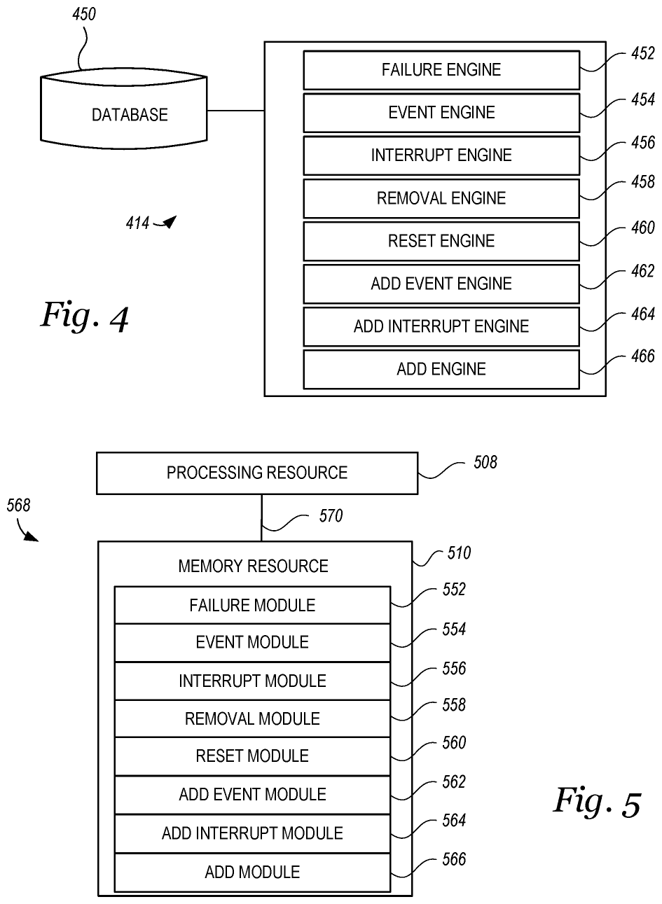

FIG. 4 is a diagram of a system 414 for providing availability of passthrough devices configured on VCIs according to one or more embodiments of the present disclosure. The system 414 can include a database 450 and/or a number of engines, for example failure engine 452, event engine 454, interrupt engine 456, removal engine 458, reset engine 460, add event engine 462, add interrupt engine 464, and/or add engine 466 and can be in communication with the database 450 via a communication link. The system 414 can include additional or fewer engines than illustrated to perform the various functions described herein. The system can represent program instructions and/or hardware of a machine (e.g., machine 568 as referenced in FIG. 5, etc.). As used herein, an “engine” can include program instructions and/or hardware, but at least includes hardware. Hardware is a physical component of a machine that enables it to perform a function. Examples of hardware can include a processing resource, a memory resource, a logic gate, an application specific integrated circuit, a field programmable gate array, etc.

The number of engines can include a combination of hardware and program instructions that is configured to perform a number of functions described herein. The program instructions (e.g., software, firmware, etc.) can be stored in a memory resource (e.g., machine-readable medium) as well as hard-wired program (e.g., logic). Hard-wired program instructions (e.g., logic) can be considered as both program instructions and hardware.

In some embodiments, the failure engine 452 can include a combination of hardware and program instructions that is configured to receive a notification of a failure associated with a passthrough device configured on a VCI. In some embodiments, the event engine 454 can include a combination of hardware and program instructions that is configured to communicate a hot remove event to a configuration file and a host agent of the VCI. In some embodiments, the interrupt engine 456 can include a combination of hardware and program instructions that is configured to communicate, by the configuration file, a hot remove interrupt to a guest OS running on the VCI. In some embodiments, the removal engine 458 can include a combination of hardware and program instructions that is configured to remove the device by the guest OS responsive to receiving the hot remove interrupt. In some embodiments, the reset engine 460 can include a combination of hardware and program instructions that is configured to reset the device. In some embodiments, the add event engine 462 can include a combination of hardware and program instructions that is configured to communicate a hot add event to the configuration file. In some embodiments, the add interrupt engine 464 can include a combination of hardware and program instructions that is configured to communicate, by the configuration file, a hot add interrupt to the guest OS. In some embodiments, the add engine 466 can include a combination of hardware and program instructions that is configured to add the device, by the guest OS, responsive to receiving the hot add interrupt.

FIG. 5 is a diagram of a machine for providing availability of passthrough devices configured on VCIs according to one or more embodiments of the present disclosure. The machine 568 can utilize software, hardware, firmware, and/or logic to perform a number of functions. The machine 568 can be a combination of hardware and program instructions configured to perform a number of functions (e.g., actions). The hardware, for example, can include a number of processing resources 508 and a number of memory resources 510, such as a machine-readable medium (MRM) or other memory resources 510. The memory resources 510 can be internal and/or external to the machine 568 (e.g., the machine 568 can include internal memory resources and have access to external memory resources). In some embodiments, the machine 568 can be a VCI. The program instructions (e.g., machine-readable instructions (MRI)) can include instructions stored on the MRM to implement a particular function (e.g., an action such as registering an NKP, as described herein). The set of MRI can be executable by one or more of the processing resources 508. The memory resources 510 can be coupled to the machine 568 in a wired and/or wireless manner. For example, the memory resources 510 can be an internal memory, a portable memory, a portable disk, and/or a memory associated with another resource, e.g., enabling MM to be transferred and/or executed across a network such as the Internet. As used herein, a “module” can include program instructions and/or hardware, but at least includes program instructions.

Memory resources 510 can be non-transitory and can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change memory (PCM), 3D cross-point, ferroelectric transistor random access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, magnetic memory, optical memory, and/or a solid state drive (SSD), etc., as well as other types of machine-readable media.

The processing resources 508 can be coupled to the memory resources 510 via a communication path 570. The communication path 570 can be local or remote to the machine 568. Examples of a local communication path 570 can include an electronic bus internal to a machine, where the memory resources 510 are in communication with the processing resources 408 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof. The communication path 570 can be such that the memory resources 510 are remote from the processing resources 508, such as in a network connection between the memory resources 510 and the processing resources 508. That is, the communication path 570 can be a network connection. Examples of such a network connection can include a local area network (LAN), wide area network (WAN), personal area network (PAN), and the Internet, among others.

As shown in FIG. 5, the MM stored in the memory resources 510 can be segmented into a number of modules 552, 554, 556, 558, 560, 562, 564, 566 that when executed by the processing resources 508 can perform a number of functions. As used herein a module includes a set of instructions included to perform a particular task or action. The number of modules 552, 554, 556, 558, 560, 562, 564, 566 can be sub-modules of other modules. For example, the add event module 562 can be a sub-module of the add interrupt module 564 and/or can be contained within a single module. Furthermore, the number of modules 552, 554, 556, 558, 560, 562, 564, 566 can comprise individual modules separate and distinct from one another. Examples are not limited to the specific modules 552, 554, 556, 558, 560, 562, 564, 566 illustrated in FIG. 5.

Each of the number of modules 552, 554, 556, 558, 560, 562, 564, 566 can include program instructions and/or a combination of hardware and program instructions that, when executed by a processing resource 508, can function as a corresponding engine as described with respect to FIG. 4. For example, the failure module 552 can include program instructions and/or a combination of hardware and program instructions that, when executed by a processing resource 508, can function as the failure engine 452, though embodiments of the present disclosure are not so limited.

The machine 568 can include a failure module 552, which can include instructions to receive a notification of a failure associated with a passthrough device configured on a VCI. The machine 568 can include an event module 554, which can include instructions to communicate a hot remove event to a configuration file and a host agent of the VCI. The machine 568 can include an interrupt module 556, which can include instructions to communicate, by the configuration file, a hot remove interrupt to a guest OS running on the VCI. The machine 568 can include a removal module 558, which can include instructions to remove the device by the guest OS responsive to receiving the hot remove interrupt. The machine 568 can include a reset module 560, which can include instructions to reset the device. The machine 568 can include an add event module 562, which can include instructions to communicate a hot add event to the configuration file. The machine 568 can include an add interrupt module 564, which can include instructions to communicate, by the configuration file, a hot add interrupt to the guest OS. The machine 568 can include an add module 566, which can include instructions to add the device, by the guest OS, responsive to receiving the hot add interrupt.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but embodiments may provide some, all, or none of such advantages, or may provide other advantages.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
receiving a notification of a failure associated with a passthrough device configured on a virtual computing instance (VCI);
communicating, to the VCI, a simulation of a surprise hot removal of the device from the VCI;
resetting the device;
communicating, to the VCI, a simulation of a surprise hot add of the device to the VCI; and
hot adding the device to the VCI.

2. The method of claim 1, wherein the method includes receiving the notification via Advanced Configuration and Power Interface (ACPI) Error Disconnect Recover (EDR).

3. The method of claim 1, wherein communicating, to the VCI, the simulation of the surprise hot removal of the device includes communicating a hot remove event to a configuration file and a host agent of the VCI.

4. The method of claim 3, wherein the method includes communicating, by the configuration file, a hot remove interrupt to a guest operating system (OS) running on the VCI.

5. The method of claim 4, wherein the method includes removing the device by the guest OS responsive to receiving the hot remove interrupt.

6. The method of claim 1, wherein communicating, to the VCI, the simulation of the surprise hot add of the device includes communicating a hot add event to the configuration file and the host agent.

7. The method of claim 6, wherein the method includes communicating, by the configuration file, a hot add interrupt to the guest OS.

8. The method of claim 7, wherein the method includes adding the device, by the guest OS, responsive to receiving the hot add interrupt.

9. The method of claim 1, wherein the method includes:
removing the device by the guest OS and notifying an administrator without hot adding the device to the VCI responsive to repeating the method a threshold quantity of times.

10. The method of claim 9, wherein the method includes receiving a user input that specifies the threshold quantity of times.

11. The method of claim 1, wherein the device is one of:
a storage device;
a networking device; and
a graphics device.

12. A non-transitory machine-readable medium having instructions stored thereon which, when executed by a processor, cause the processor to:
receive a notification of a failure associated with a passthrough device configured on a virtual computing instance (VCI);
communicate a hot remove event to a configuration file and a host agent of the VCI
communicate, by the configuration file, a hot remove interrupt to a guest operating system (OS) running on the VCI;
remove the device by the guest OS responsive to receiving the hot remove interrupt;
reset the device;
communicate a hot add event to the configuration file;
communicate, by the configuration file, a hot add interrupt to the guest OS; and
add the device, by the guest OS, responsive to receiving the hot add interrupt.

13. The medium of claim 12, wherein the failure is detected by the passthrough device.

14. The medium of claim 12, wherein the failure is a peripheral component interconnect express (PCLe) uncorrectable error.

15. The medium of claim 12, wherein the failure is an input-output memory management unit (IOMMU) fault.

16. The medium of claim 12, wherein the instructions to add the device, by the guest OS, responsive to receiving the hot add interrupt include instructions to rediscover the passthrough device and load drivers associated with the passthrough device.

17. The medium of claim 12, wherein the instructions do not include instructions to terminate the VCI.

18. A system, comprising:
a failure engine configured to receive a notification of a failure associated with a passthrough device configured on a virtual computing instance (VCI);
an event engine configured to communicate a hot remove event to a configuration file and a host agent of the VCI;
an interrupt engine configured to communicate, by the configuration file, a hot remove interrupt to a guest operating system (OS) running on the VCI;
a removal engine configured to remove the device by the guest OS responsive to receiving the hot remove interrupt;
a reset engine configured to reset the device;
an add event engine configured to communicate a hot add event to the configuration file;
an add interrupt engine configured to communicate, by the configuration file, a hot add interrupt to the guest OS; and
an add engine configured to add the device, by the guest OS, responsive to receiving the hot add interrupt.

19. The system of claim 18, wherein the reset engine is configured to reset the device such that the device returns to an accessible state.

20. The system of claim 18, wherein the passthrough device is a peripheral component interconnect (PCI) device.
